(19) United States
(12) Patent Application Publication
(10) Pub. No.: US 2025/0136162 A1
(43) Pub. Date: May 1, 2025

(54) Electrified Hydraulic Lift Table

(71) Applicant: Robert Bosch GmbH, Stuttgart (DE)

(72) Inventors: Daniel Newkirk, Owatonna, MN (US); Antony Sankoorikal, Bengaluru (IN); Ian Ferguson, Lathrup Village, MI (US); Gautam Vikas, Chhattisgarh (IN); Corday Peterson, Fountain, MN (US)

(21) Appl. No.: 18/923,766

(22) Filed: Oct. 23, 2024

Related U.S. Application Data
(60) Provisional application No. 63/546,843, filed on Nov. 1, 2023.

(51) Int. Cl. B62B 3/04; B62B 5/00; B62B 5/06

(52) U.S. Cl. CPC B62B 3/04; B62B 5/004; B62B 5/0069; B62B 5/06; B62B 2202/61; B62B 2203/10; B62B 2301/254

(57) ABSTRACT

A service cart for an electric vehicle (EV) battery, comprising a lift assembly supporting a platform. The platform is configured to support the EV battery. The service cart comprises an electrically-driven hydraulic pump that is configured to extend and retract the lift assembly in order to raise and lower the platform. The service cart may comprise one or more electric wheels which may be driven by rotational force from a first electric motor, or controlled with respect to an adjustable directionality by a second electric motor.

### TECHNICAL FIELD

This disclosure relates to the repair and maintenance of electric vehicles and their associated batteries. More specifically, this disclosure relates to tools useful in the repair and maintenance of electrical vehicles and their associated batteries.

### BACKGROUND

Electric vehicles are becoming more popular as their versatility and reliability improves. Electric vehicles and their respective components still require servicing for repair and maintenance operations. Most electric vehicles feature a large, heavy battery suitable to drive the prime mover of the vehicle, which often must be removed from the chassis of the vehicle to perform certain important servicing to the vehicle or to the battery itself. Because of their size and weight, removal of the batteries from their respective chassis is often difficult and time-consuming, and may require specialized tools in a specialized shop environment. Such tools are often expensive, cumbersome, and difficult to store. Such tools are frequently dependent upon additional features of the shop in which they are used, such as a compressed air system. What is desired is an affordable and effective tool for removing, servicing, and moving heavy electric vehicle batteries that is portable and not reliant upon additional shop features.

### SUMMARY

One aspect of this disclosure is directed to a service cart configured to support an electric vehicle battery. The service cart comprises a support frame, a plurality of wheels, a lift assembly supported by the support frame, and a hydraulic pump. Each of the plurality of wheels has an adjustable directionality with respect to the support frame. The lift assembly is supported by the support frame at a proximal end of the lift assembly. The platform is supported by the lift assembly and arranged at a distal end of the lift assembly. The platform is configured to support the electric vehicle battery. The hydraulic pump is an electrically-driven hydraulic pump interfacing with the lift assembly. The electrically-driven hydraulic pump is operable to raise and lower the platform by extending and retracting the lift assembly respectively. The service cart may further comprise a handle coupled to the support frame. The handle may further comprise electric controls configured to control the electrically-driven hydraulic pump. In some embodiments, the lift assembly comprises a scissor-lift assembly. Some embodiments further comprise a first electric motor, and at least one of the wheels comprises an electric wheel that is driven by the first electric motor. Some embodiments further comprise a first electric motor and a second electric motor, wherein the first electric motor drives the electric wheel rotationally and the second electric motor is configured to control the directionality of the electric wheel with respect to the support frame.

Another aspect of this disclosure is directed to a service cart configured to support an electric vehicle battery. The service cart comprises a support frame, a plurality wheels coupled to the support frame, a lift assembly supported by the support frame at a proximal end of the lift assembly, a platform supported by the lift assembly and arranged at a distal end of the lift assembly, an electrically-driven hydraulic pump interfacing with the lift assembly, and electric controls configured to control the hydraulic pump. The electrically-driven hydraulic pump is operable to raise and lower the platform by extending and retracting the lift assembly respectively. Each of the plurality of wheels is an omni-directional wheel having a controlled adjustable directionality with respect to the support frame. In some embodiments, each of the plurality of wheels may comprise a plurality of rolling spindles distributed about a circumference of the wheel. In some embodiments, one or more of the wheels may comprise an electric wheel. Some embodiments may comprise a first electric motor that provides rotational drive to one or more of the electric wheels. Some embodiments may comprise a first electric motor that provides rotational drive to one or more of the electric wheels and a second electric drive that controls the directionality of the one or more electric wheels with respect to the support frame.

A further aspect of this disclosure is directed to a service cart configured to support an electric vehicle battery. The service cart comprises a support frame, a plurality of wheels, a lift assembly, a platform, an electric hydraulic pump, a battery, and electric controls. The plurality of wheels are coupled to the support frame. The lift assembly is supported by the support frame at a proximal end of the lift assembly. The platform is supported by the lift assembly and arranged at a distal end of the lift assembly. The electrically-driven hydraulic pump interfaces with the lift assembly, and the electrically-driven hydraulic pump is operable to raise and lower the platform by extending and retracting the lift assembly respectively. The battery is in electric connection with the electrically-driven hydraulic pump and configured to drive the electrically-driven hydraulic pump. The electric controls are configured to control the electrically-driven hydraulic pump. Each of the plurality of wheels may be an omni-directional wheel having a controlled adjustable directionality with respect to the support frame. Each of the plurality of wheels further comprises a plurality of rolling spindles distributed about a circumference of the wheel. Some embodiments may comprise a first electric motor, and at least one of the wheels comprises an electric wheel wherein the first electric motor is configured to drive the electric wheel with rotation force. Some embodiments may further comprise a second electric motor, the second electric motor configured to control the directionality of the at least one electric wheel with respect to the support frame.

The above aspects of this disclosure and other aspects will be explained in greater detail below with reference to the attached drawings.

### BRIEF DESCRIPTION OF THE DRAWINGS

FIG. 1 is an illustration of an electrified lift cart for electric vehicle service according to a first embodiment of the teachings herein.

FIG. 2 is an illustration of an electrified lift cart for electric vehicle service according to a second embodiment of the teachings herein.

FIG. 3 is an illustration of an electrified lift cart for electric vehicle service according to a second embodiment of the teachings herein.

FIG. 4 is a close-up look of an omni-direction wheel of the electrified service cart of FIG. 3.

FIG. 5 is an illustration depicting an arrangement of electric controls for an electrified service cart.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

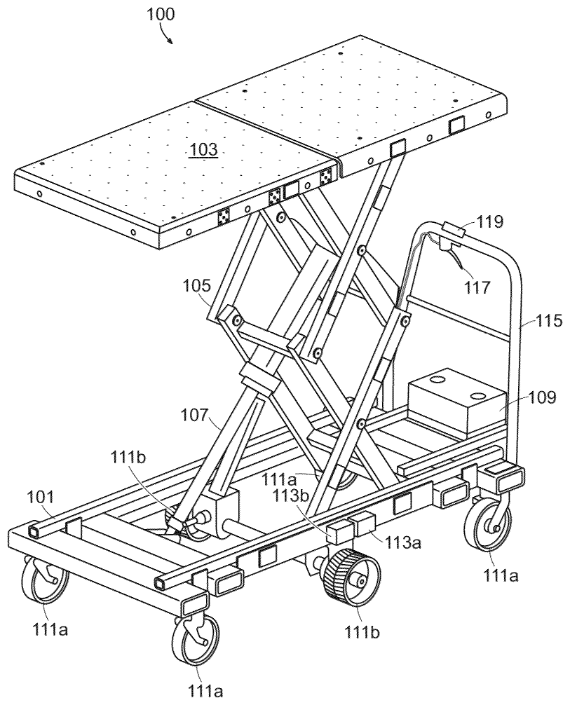

FIG. 1 shows a service cart 100 according to a first embodiment of the teachings disclosed herein. Service cart 100 comprises a support frame 101, a platform 103, a lift assembly 105, and a hydraulic pump 107.

Support frame 101 provides a structural element to which other elements of service cart 100 can be coupled. Support frame 101 comprises rectangular arrangement of support members in the depicted embodiment, but other embodiments may comprise other configurations without deviating from the teachings disclosed herein.

Removal of the battery from an electric vehicle (EV) is frequently necessary during service of the EV or its associated battery (a so-called “EV battery”). In this embodiment, service cart 100 is an electrified lifting cart configured to lift and support an EV battery during service of an EV or of the EV battery itself. Service cart 100 utilizes a platform 103 to provide a surface upon which an EV battery can rest during service. Platform 103 is arranged at one end of a lift assembly 105 suitable to provide support for the weight of an EV battery, and additionally suitable to provide position in a vertical direction during service. Lift assembly 105 is supported at its other end—opposite from the end support platform 103—by support frame 101. From the perspective of support frame 101, platform 103 is arranged at the distal end of lift assembly 105, whereas the proximal end of lift assembly 105 is supported by support frame 101. Other arrangements or other perspectives may be comprised in other embodiments without deviating from the teachings disclosed herein.

By way of example, and not limitation, a particular utilization of service cart 100 may comprise extending the lift assembly 105 underneath a suspended EV during service so that the associated EV battery may be placed upon platform 103. After removal of the EV battery from the EV and placement of the EV battery upon platform 103, the loaded platform 103 may be lowered by retracting lift assembly 105 so that the EV battery is held at a height that is suitable and safe for maneuvering service cart 100. Once service is completed, the lift assembly 105 may be extended again to re-position the EV battery into place suitable for re-coupling to the EV.

In the depicted embodiment, lift assembly 105 comprises a scissor-lift assembly, which is configured to extend to raise platform 103 and retract to lower platform 103. Other embodiments may comprise other configurations without deviating from the teachings disclosed herein. Other such embodiments may comprise a telescoping lift, an extensible lift member, a lever-operated lift, or any other lift mechanism recognized by one of ordinary skill without deviating from the teachings disclosed herein. Advantageously, the scissor-lift mechanism of lift assembly 105 minimizes the horizontal space necessarily to effectively extend and retract, improving the portability and maneuverability of service cart 100.

EV batteries are heavy, so providing active assistance to the extension and retraction of lift mechanism 105 enhances the utility and safety of service cart 100. In the depicted embodiment, lift mechanism 105 is substantially enhanced in its capacity by a hydraulic pump 107. Hydraulic pump 107 interfaces with lift mechanism 105 to minimize the manual work effort required to adjust the position of platform 103. Conventional hydraulic pumps may be operated by utilizing external energy, such as air pressure provided by a pressurized air system external to service cart 100. However, such conventional arrangements require that hydraulic pumps be in gaseous communication with a source of pressurized air, such as a tube connection to a tank or air compressor. This form of tube connection effectively acts as a tether to the tank or air compressor, reducing the maneuverability and portability of service cart 100. Additionally, some shops may not be equipped with a sufficient air compression system to engage conventional hydraulic pumps. In the depicted embodiment, hydraulic pump 107 is an electrically-driven hydraulic pump: electrical energy is used to engage the hydraulic elements of the pump. Advantageously, an electrically-driven hydraulic pump 107 can be utilized with much more readily-available electrical power. In the depicted embodiment, electrically-driven hydraulic pump 107 is driven by power supplied by a battery 109, but other embodiments may comprise other arrangements without deviating from the teachings disclosed herein. Advantageously, battery 109 is coupled to support frame 101, optimizing the portability and maneuverability of service cart 100. Other embodiments may comprise an external power implementation, such as a port for a power cable, without deviating from the teachings disclosed herein. In such embodiments, the electric elements of service cart 100 may advantageously be powered without concern for how much power is stored within a battery, while still providing a more ergonomic and flexible power supply than an air compression hose. In some embodiments, service cart 100 may comprise both an electric port and a battery 109 to maximize flexible operation. In such embodiments, the electric port may be utilized to re-charge battery 109 without deviating from the teachings disclosed herein.

Support frame 101 further comprises a number of wheels 111. Wheels 111 enable movement of service cart 100 within a working environment, either when service cart 100 is unloaded or loaded. In the depicted embodiment, wheels 111 comprise a plurality of passive wheels 111a and an additional pair of electric wheels 111b. Passive wheels 111a are passive multi-directional casters enabling maneuvering of service cart 100.

Electric wheels 111b are configured to be driven by one or more electric motors 113. In the depicted embodiment, a first electric motor 113a is configured to drive electric wheels 111a with rotational force. Thus, first electric motor 113a decreases the amount of work effort necessary to move service cart 100 in a forward or backward direction with respect to electric wheels 111b. This additional rotational force advantageously reduces the efforts required by a user of service cart 100 to move the cart in a linear direction while service cart 100 is loaded. A second electric motor 113b is configured to control the directionality of electric wheel 111b with respect to support frame 100. In this manner, second electric motor 113b advantageously decreases the amount of work effort necessary to align electric wheels 111b in a desired steering direction.

In the depicted embodiment, each of electric motors 113 is powered by battery 109, but other embodiments may be powered using other power sources without deviating from the teachings disclosed herein. In some embodiments, an alternative or additional power source to battery 109 may be utilized to power electric motors 113 without deviating from the teachings disclosed herein.

The depicted embodiment comprises both a first electric motor 113a and a second electric motor 113b, but other embodiments may comprise a different configuration with only one type of electric motor, without any electric motors, or with additional electric motors without deviating from the teachings disclosed herein.

Additional elements of service cart 100 are depicted illustrating ergonomic functions thereof. Service cart 100 additionally comprises a handle 115 suitable for a user to apply pushing forces to the service cart in order to move, maneuver, or position service cart 100 within a working environment. In the depicted embodiment, service cart 100 comprises a single handle 115 coupled to one side of support frame 101, but other embodiment may comprise a different arrangement or number of handles 115 without deviating from the teachings disclosed herein. Coupled to handle 115 is a brake control 117 which activates a braking mechanism (not shown) of one or more of wheels 111. In the depicted embodiment, brake control 117 comprises a mechanical cable brake, but other embodiments may comprise other configurations without deviating from the teachings disclosed herein, such as an electrically-assisted brake control. In such embodiments, the electrically-assisted braking may be powered by battery 109, or by any other power source without deviating from the teachings disclosed herein.

Additionally coupled to handle 115 are an electric control interface, providing a user with a set of electric controls 119 to control various aspects of service cart 100. In the depicted embodiment, the electric controls 119 can be utilized to operate the lift mechanism 105 or the functions of electric wheels 111b. Other embodiments may comprise a different set of controls without deviating from the teachings disclosed herein.

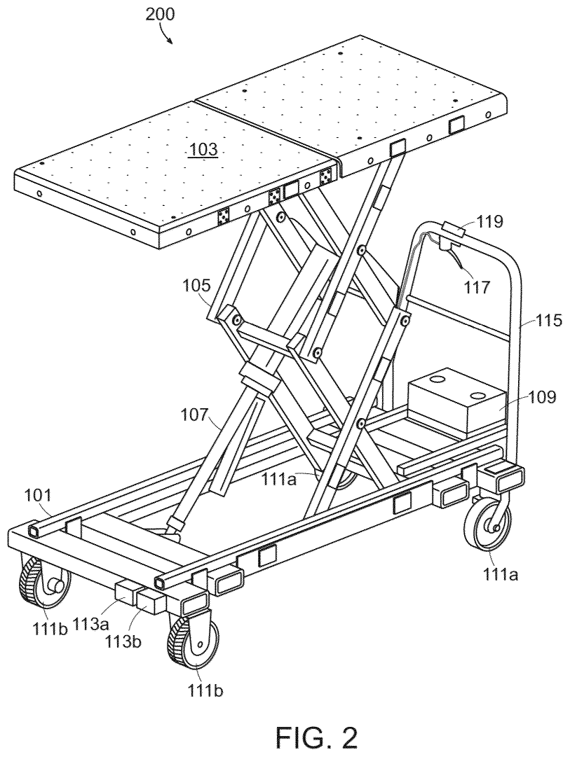

FIG. 2 presents an alternative embodiment of a service cart 200 according to the teachings disclosed herein. In this embodiment, service cart 200 comprises four wheels 111, with two of the wheels closest to handle 115 being passive casters 111a and the remaining two wheels being electric wheels 111b. In the depicted embodiment, electric motors 113 have also been relocated on support frame 101 to minimize the distance between them and the electric wheels 111b which they control, but other embodiments may comprise other configurations without deviating from the teachings disclosed herein. In the depicted embodiment, service cart 200 can provide substantially similar performance as service cart 100 with reduced costs because of the fewer components utilized.

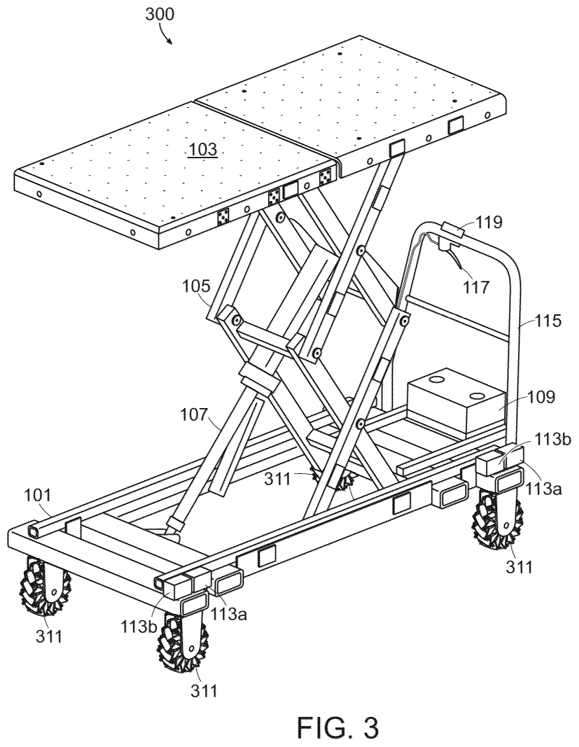

Other embodiments may comprise different configurations. FIG. 3 illustrate another alternative embodiment of a service cart 300 that is substantially the same as service cart 200, except it utilizes a different configuration of wheels 311. In the depicted embodiment, all of wheels 311 comprise electric wheels having an omni-directional configuration. The omni-direction wheels 311 each have a controlled adjustable directionality with respect to the support frame 101.

The rotation of each of the wheels 311 may be driven by a first electric motor 113a. In the depicted embodiment, each of the wheels 311 is driven with rotational forces provided by its own associated first electric motor 113a, but other embodiments may comprise a different number of first electric motors 113a without deviating from the teachings disclosed herein.

The adjustable directionality of each of wheels 311 may be controlled by a second electric motor 113b. In the depicted embodiment, each of the wheels 311 is controlled by its own associated second electric motor 113b, but other embodiments may comprise a different number of second electric motors 113b without deviating from the teachings disclosed herein.

Control of the rotation and directionality of wheels 311 is accomplished using the electric controls 119 of service cart 300. Utilization of the omni-directional electric wheels 311 advantageously provides maximal maneuverability of service cart 300, even when loaded by an EV battery. In the depicted embodiment, service cart 300 may be able to spin in a complete 360-degree circle without displacing the center of mass of the service cart or any load thereof. Service cart 300 may additionally be able to move in 4 directions along a surface without reorienting support frame 100, or move at any angle between the surface directions. Lastly, because these movements are controlled and enhanced by electric controls 119, the amount of work effort necessarily exerted by a user—either via handle 115 or other portions of surface cart 300—is minimized. In the depicted embodiment, service cart 300 comprises only electric omni-directional wheels 311, but other embodiment may have a different number of electric wheels, a different number of omni-directional wheels, or a different arrangement thereof without deviating from the teachings disclosed herein.

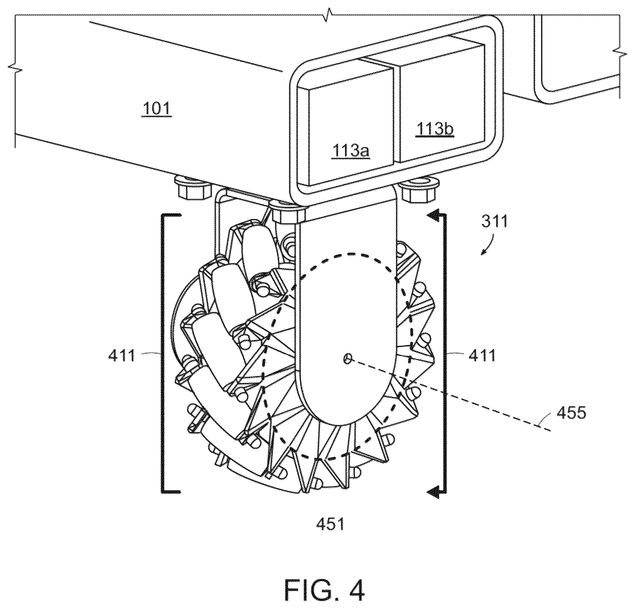

FIG. 4 provides a close-up view of one of wheels 311. Wheel 311 comprises a plurality of rolling spindles 411 arranged about the circumference of wheel 311. Each of the rolling spindles 411 is configured to roll independently of all the others. In the depicted embodiment, each of rolling spindles 411 may be driven with rotational force from an associated first electric motor 113a, but other embodiments may comprise other configurations without deviating from the teachings disclosed herein. In some such embodiments, first electric motor 113a may drive all of rolling spindles 411 of a particular wheel 311 without deviating from the teachings disclosed herein. In other embodiments, only a subset of rolling spindles 411 may be controlled by second electric motor 113b without deviating from the teachings disclosed herein.

In the depicted embodiment, the arrangement of rolling spindles 411 provide functionality to wheel 311. Distributing rolling spindles 411 about the circumference 451 of wheel 311 advantageously provides consistent operation of the wheel, irrespective of the rotational alignment. Each of the rolling spindles 411 is additionally arranged at an angle oblique to the axis 455 about which wheel 311 rotates at its circumference 451 during movement of service cart 300 (see FIG. 3). The oblique angle of the rolling spindles 411 with respect to axis 455 advantageously enhances the maneuverability of service cart 300, permitting the service cart 300 to turn with a substantially smaller turning radius.

Each of rolling spindles 411 is additionally arranged longitudinally so as to be tangent to the circumference 451 of wheel 311. This arrangement permits each of rolling spindles 411 to roll in part from passive rolling motion of the overall wheel 311, such that none of the rolling spindles 411 substantially impedes motion of wheel 311. For the purposes of this disclosure, “tangential” refers to an angle that is substantially aligned with a line, surface, that intersects with a single point of circumference 451. For the purpose of this disclosure, “substantially aligned” refers to an alignment within a specified tolerance suitable for the purposes of utility. By way of example, and not limitation, an substantially aligned element may be in alignment within 10 degrees without deviating from the teachings disclosed herein.

Control of a service cart (such as service cart 100, 200, or 300; Sec FIGS. 1, 2, and 3) can be accomplished with assistance from electric-powered components. A service cart may utilize electric wheels (such as electric wheel 111b or electric wheel 311; see FIGS. 1,2, and 3) to maneuver a service cart, which is particularly advantageous when the cart is supporting a heavy load (such as an EV battery). A service cart may utilize an electrically-driven hydraulic pump (such as hydraulic pump 107; see FIG. 1) to assist in safely and accurately raising and lowering the platform of the service cart (such as platform 103; see FIG. 1), particularly when supporting a heavy load (such as an EV battery). A set of electric controls (such as electric controls 119; see FIG. 1) can be ergonomically placed for a user to operate the electrically-supported functions of the service.

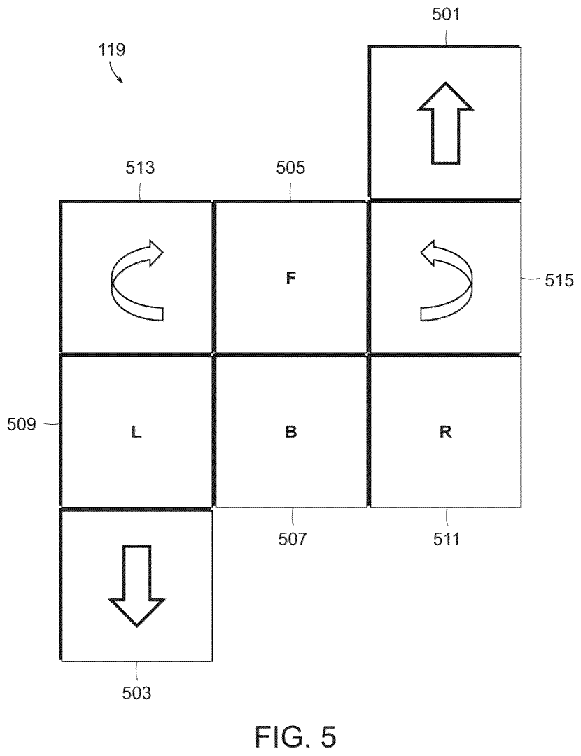

FIG. 5 is a depiction of one configuration of electric controls, showing the functions and layout thereof. In the depicted embodiment, electric controls 119 comprise a number of hardware buttons providing control signals to electric motors (such as first electric motor 113a or second electric motor 113b; see FIG. 1, 2, 3) or other electrically-driven elements (such as electrically-driven hydraulic pump 107; see FIG. 1).

The operations of the platform lifting may be accomplished using lift control buttons. In the depicted embodiment, the lift control buttons comprise an UP button 501 and a DOWN button 503. UP button 501 controls an electrically-driven hydraulic pump to extend a lift assembly of the service cart (such as lift assembly 105; see FIG. 1). DOWN button 503 controls the electrically-driven hydraulic pump to retract the lift assembly. In the depicted embodiment, extension of the lift assembly raises a platform (such as platform 103; see FIG. 1) and retraction lowers the platform, but other embodiments may comprise other configurations without deviating from the teachings thereof. In the depicted embodiment, each of UP button 501 and DOWN button 503 may be depressed when the lift assembly reaches the linear end of its extension or retraction. However, when the lift assembly has been maximally extended, the UP button 501 will no longer have an impact on the condition of the service cart. Similarly, when the lift assembly has been maximally retracted, the DOWN button 503 will no longer have an impact on the condition of the service cart.

The service cart may be maneuvered using directional movement control buttons. In the depicted embodiment, the directional movement control buttons comprise a FORWARD button 505, a BACK button 507, a LEFT button 509, a RIGHT button 511, a CLOCKWISE button 513, and a COUNTER-CLOCKWISE button 515. Each of these directional movement control buttons provide control signals to electric motors that move the service cart via one or more electric wheels. The motion is defined relative to perspective of the ergonomic user operating position of the electric controls. By way of example, and not limitation, each of these buttons may implement motion of service cart 100 in the directions indicated from the perspective of a user standing beside handlebar 115 and facing service cart 100 (see FIG. 1).

In such a configuration, FORWARD, BACK, LEFT, and RIGHT represent linear motions of the associated service cart. FORWARD button 505 and BACK button 509 respectively move the associated service cart forward and backward with respect to the perspective of the electronic controls. LEFT button 511 and RIGHT button 513 respectively “strafe” the service cart to the left or right respectively: moving the service cart respectively to the left or right without reorienting the cart. CLOCKWISE button 513 and COUNTER-CLOCKWISE button 515 act as rotational directional controls. CLOCKWISE motion corresponds to a “rightward swivel” from the perspective of the electric controls, and COUNTER-CLOCKWISE corresponds to a “leftward swivel” motion. In the depicted embodiment, CLOCKWISE button 513 and COUNTER-CLOCKWISE button 515 rotate the orientation of the service cart without moving the center of mass of the service cart, effectively behaving as a “swivel in place” function, but other embodiments may adjust the orientation of the cart as well as moving the cart in a linear capacity, providing a “turning” functionality instead, without deviating from the teachings disclosed herein.

In the depicted embodiment, two or more of the buttons of electronic controls may be depressed concurrently, providing a greater range of motions and maneuvers to the user. By way of example, and not limitation, a linear motion and rotational motion of the service cart can be activated simultaneously to achieve “turning” functionality. In the even that two “opposite” controls are depressed at the same time, the electric controls can instigate no motion at all until a prevailing control is selected and depressed alone.

The depicted embodiment comprises 8 controls in a particular arrangement, but other embodiments may comprise a different set of controls, different arrangement of controls, additional controls, fewer controls, or some combination of the above without deviating from the teachings disclosed herein. By way of example, and not limitation, a service cart that does not comprise an electric motor suitable to adjust the directionality of an electric wheel (such as second electric motor 113b; see FIG. 1, 2, 3, 4) may not comprise a LEFT, RIGHT, CLOCKWISE, or COUNTER-CLOCKWISE function, without deviating from the teachings disclosed herein. Other embodiments may comprise other configurations without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A service cart configured to support an electric vehicle battery comprising:
a support frame;
a plurality of wheels coupled to the support frame, each of the wheels having an adjustable directionality with respect to the support frame;
a lift assembly supported by the support frame at a proximal end of the lift assembly;
a platform supported by the lift assembly and arranged at a distal end of the lift assembly, the platform configured to support the electric vehicle battery;
an electrically-driven hydraulic pump interfacing with the lift assembly, the electrically-driven hydraulic pump operable to raise and lower the platform by extending and retracting the lift assembly respectively; and
a handle coupled to the support frame,
wherein
the handle further comprises electric controls configured to control the electrically-driven hydraulic pump.

2. The service cart of claim 1, wherein the lift assembly comprises a scissor-lift assembly, and the scissor-lift assembly extends and retracts to respectively raise and lower the platform.

3. The service cart of claim 1, further comprising a first electric motor, and wherein at least one of the plurality of wheels comprises an electric wheel, the first electric motor configured to drive the electric wheel with rotational force.

4. The service cart of claim 3, wherein the electric controls are configured to control the first electric motor.

5. The service cart of claim 3, further comprising a second electric motor, wherein the second electric motor is configured to control the directionality of the at least one electric wheel with respect to the support frame.

6. The service cart of claim 5, wherein the electric controls are configured to control the first electric motor and the second electric motor.

7. The service cart of claim 3, wherein each of the plurality of wheels comprises an omni-directional wheel having a plurality of rolling spindles distributed about a circumference of the wheel.

8. The service cart of claim 7, wherein each of the plurality of rolling spindles is configured to roll independently of the other rolling spindles of the same wheel.

9. A service cart configured to support an electric vehicle battery comprising:
a support frame;
a plurality wheels coupled to the support frame;
a lift assembly supported by the support frame at a proximal end of the lift assembly;
a platform supported by the lift assembly and arranged at a distal end of the lift assembly;
an electrically-driven hydraulic pump interfacing with the lift assembly, the electrically-driven hydraulic pump operable to raise and lower the platform by extending and retracting the lift assembly respectively; and
electric controls configured to control the hydraulic pump,
wherein
each of the plurality of wheels is an omni-directional wheel having a controlled adjustable directionality with respect to the support frame.

10. The service cart of claim 9, wherein each of the wheels comprises a plurality of rolling spindles distributed about a circumference of the wheel.

11. The service cart of claim 10, wherein each of the rolling spindles is arranged at an angle oblique to an axis of the wheel about which the wheel rotates.

12. The service cart of claim 10, wherein each of the plurality of rolling spindles is configured to roll independently of the other rolling spindles.

13. The service cart of claim 9, further comprising a first electric motor, and wherein at least one of the plurality of wheels comprises an electric wheel, the first electric motor configured to drive the electric wheel with rotational force.

14. The service cart of claim 13, further comprising a second electric motor, wherein the second electric motor is configured to control the directionality of the at least one electric wheel with respect to the support frame.

15. The service cart of claim 14, wherein the electric controls control the first electric motor and the second electric motor.

16. A service cart configured to support an electric vehicle battery comprising:
a support frame;
a plurality of wheels coupled to the support frame;
a lift assembly supported by the support frame at a proximal end of the lift assembly;
a platform supported by the lift assembly and arranged at a distal end of the lift assembly;
an electrically-driven hydraulic pump interfacing with the lift assembly, the electrically-driven hydraulic pump operable to raise and lower the platform by extending and retracting the lift assembly respectively;
a battery in electric connection with the electrically-driven hydraulic pump, the battery configured to drive the electrically-driven hydraulic pump; and
electric controls configured to control the electrically-driven hydraulic pump,
wherein
each of the plurality of wheels is an omni-directional wheel having a controlled adjustable directionality with respect to the support frame, and
each of the plurality of wheels comprises a plurality of rolling spindles distributed about a circumference of the wheel.

17. The service cart of claim 16, further comprising a first electric motor, and wherein at least one of the plurality of wheels comprises an electric wheel, the first electric motor configured to drive the electric wheel with rotational force.

18. The service cart of claim 17, further comprising a second electric motor, wherein the second electric motor is configured to control the directionality of the at least one electric wheel with respect to the support frame.

19. The service cart of claim 18, wherein the electric controls are configured to control the first electric motor and the second electric motor.

20. The service cart of claim 16, wherein each of the rolling spindles is arranged at an angle tangent to the circumference of the wheel and oblique to an axis of the wheel about which the wheel rotates, and wherein each of the plurality of rolling spindles is configured to roll independently of the other rolling spindles.
